(19) United States
(12) Patent Application Publication
(10) Pub. No.: US 2023/0343949 A1
(43) Pub. Date: Oct. 26, 2023

(54) POSITIVE ELECTRODE ACTIVE MATERIAL FOR PROTON CONDUCTING SECONDARY BATTERIES, AND PROTON CONDUCTING SECONDARY BATTERY PROVIDED WITH SAME

(71) Applicant: KAWASAKI MOTORS, LTD., Hyogo (JP)

(72) Inventors: Kwohsiung YOUNG, Hyogo (JP); Kousuke NAKAYAMA, Hyogo (JP); Chiaki MATSUDA, Hyogo (JP)

(73) Assignee: KAWASAKI MOTORS, LTD., Hyogo (JP)

(21) Appl. No.: 18/215,383

(22) Filed: Jun. 28, 2023

Related U.S. Application Data
(63) Continuation of application No. PCT/JP2020/049284, filed on Dec. 29, 2020.

(51) Int. Cl. H01M 4/505; H01M 4/525; H01M 4/131; H01M 10/34; C01G 53/00

(52) U.S. Cl. CPC H01M 4/505; H01M 4/525; H01M 4/131; H01M 10/342; C01G 53/50; C01P 2006/40; C01P 2002/50

(57) ABSTRACT

A cathode-active material for a proton-conducting secondary battery, the cathode-active material being for use in a proton-conducting secondary battery, the cathode-active material comprising a compound that is a solid solution that has a composition containing Mn.

### CROSS REFERENCE TO THE RELATED APPLICATION

This application is a continuation application, under 35 U.S.C. § 111(a) of international patent application No. PCT/JP2020/049284, filed Dec. 29, 2020, the entire disclosure of which is herein incorporated by reference as a part of this application.

### BACKGROUND OF THE INVENTION

### Field of the Invention

The present invention relates to a cathode active material for proton conducting secondary batteries, and a proton conducting secondary battery including the same.

### Description of Related Art

The alkali metals with low electrochemical equivalent weight, such as lithium, have been particularly attractive as a battery component. Lithium can provide greater energy per weight than previously used nickel and cadmium. An important problem to be solved in the development of rechargeable lithium metal batteries, however, is to achieve an effective charge/discharge cycling. On repeated charge and discharge in such kind of batteries, lithium “dendrites” are gradually produced on the surface of the lithium metal electrode. These may eventually grow to such an extent that they come into contact with the cathode, and that will cause an internal short circuit in the battery, rendering the battery unusable after, just a relatively few cycles. Moreover, although silicon has been commonly used as an anode material in lithium-ion batteries because of its very high theoretical specific capacity (4000 mAh/g), it will cause dramatical volumetric lattice expansion as much as 400% when cycled with lithium. Such an expansion will further bring about a reduced cycle life and will result in uncapable to be effectively used in many systems.

Instead of the technology utilizing rechargeable batteries, it appears that the technology utilizing hydrogen atoms with very low molecular weights as the substances to be cycled is prospective. It is known that some of the metal hydride alloys such as nickel hydroxide are known to be capable of storing and releasing hydrogen. When such materials are used together with an appropriate anode material, these hydrogen-storage materials will become available in fuel cells and metal hydride batteries (e.g., see Patent Document 1).

### RELATED DOCUMENT

### Patent Document

[Patent Document 1] U.S. Pat. No. 5,536,591

### SUMMARY OF THE INVENTION

Conventionally, with respect to the above-described metal hydroxide batter, a hydroxide of a mixture of transition metals, which contain nickel as a main component, has been generally used as a cathode active material. However, when such a cathode active material is used, it is difficult to achieve a sufficient charge/discharge capacity in the battery.

In order to overcome the above-described problem, an object of the present invention is to provide a cathode active material which can improve the charge/discharge capacity characteristics in a proton conducting secondary battery.

In order to attain the above-described object, according to the present invention, a cathode active material to be used for a proton conducting second battery is provided. Such a material consists of compounds in a state of solid solution, the compounds containing Mn as a composition.

According to such a configuration, the discharge capacity of a proton conducting secondary battery and the charge/discharge-cycle characteristics of the same, in which the cathode active material is used, can be dramatically improved.

In a cathode active material according to one embodiment of the present invention, the active material may be a compound having a composition represented by the following formula (1):

[Chem. 1]

MnₐM₁₋ₐOₓH_{y} (1)

(wherein M represents a metal element other than Mn or a combination of metal elements; 0<a≤1; 1≤x≤4; and 0≤y≤7). Optionally, M in the formula (1) may be one element selected from the group consisting of Co, Ni, Li, and Bi, or a combination thereof.

Optionally, in the cathode active material according to one embodiment of the present invention, a>0.5, preferably a>0.8, more preferably a>0.9, further preferably a>0.95.

A proton conducting secondary battery according to the present invention comprises: a cathode containing the cathode active material; an anode containing an anode active material capable of storing and releasing hydrogen; and a non-aqueous electrolyte intervening between the cathode and the anode.

According to this configuration, the discharge capacity of the proton conducting secondary battery and the charge/discharge-cycle characteristics of the same can be dramatically improved.

Any combination of at least two constructions, disclosed in the appended claims and/or the specification and/or the accompanying drawing can be construed as included within the scope of the present invention. In particular, any combination of two or more of the appended claims can be equally construed as included within the scope of the present invention.

### BRIEF DESCRIPTION OF THE DRAWING

In any event, the present invention will become more clearly understood from the following description of a preferred embodiment thereof, when taken in conjunction with the accompanying drawing. However, the embodiment and the drawing are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and;

FIG. 1 is a sectional view schematically showing a test cell for testing characteristics of an electrolyte according to one example of the present invention.

### DESCRIPTION OF EMBODIMENTS

Hereinafter, an embodiment according to the present invention will be described with reference to the drawing, but the present invention will not be limited to the embodiment.

Regarding the present embodiment, a cathode-active material used in a secondary battery of a proton-conducting type contains a compound in a state of solid solution having a composition including Mn. As described in detail below, the applicant has found that the use of such a material as a cathode-active material for a secondary battery of a proton-conducting type can dramatically improve the discharge capacity of the proton conducting secondary battery and the charge/discharge cycle characteristics of the same.

The cathode-active material may be a compound having a composition represented by the following formula (1):

[Chem. 2]

MnₐM₁₋ₐOₓH_{y} (1)

(wherein M represents a metal element other than Mn or a combination of metal elements; 0<a≤1; 1≤x≤4; and 0≤y≤7). Optionally, M in the formula (1) may be one element selected from the group consisting of Co, Ni, Li, and Bi, or a combination thereof.

Optionally, in the formula (1), a>0.5, preferably a>0.8, more preferably a>0.9 and further preferably a>0.95.

The proton conducting secondary battery according to the present embodiment includes: a cathode containing a cathode-active material made from the above-described material; an anode containing an anode-active material capable of storing and releasing hydrogen; and a non-aqueous electrolyte intervening between the cathode and the anode.

The “proton-conducting secondary batteries” as provided herein differ from traditional metal-hydride batteries for many reasons including the absence of an aqueous electrolyte. This proton-conducting secondary batteries of new generation are also operated by cycling hydrogen between the anode and the cathode, similarly to the traditional batteries. The anodes thereby form hydrides with one or more elements in the anode during charge. These hydrides are formed reversibly such that during discharge, the hydrides become the elemental portions of the anode active material generating both protons and electrons.

As used herein, the “anode” refers to an electrode on a side including a substance that electrochemically accepts electrons during charge, whereas the “cathode” refers to an electrode on a side including a substance that electrochemically releases electrons during charge.

The reaction that takes place at the anode of the proton conducting secondary battery is represented by the following half reaction:

M+H⁺+e³¹ ⇄MH [Chem. 3]

wherein M as an anode active material in the formula will be described below.

The reaction that takes place at the cathode, corresponding to the above reaction, is represented by the following half reaction:

M_{c}OₓH_{y}⇄M_{c}OₓH_{y-1}+H⁺+e³¹ [Chem. 4]

wherein M_{c} in the formula is a metal element in the cathode active material exemplified in the above.

The anode active material is optionally a hydrogen-storage alloy that can store hydrogen generated electrochemically in an electrolyte during charge and that can easily release the stored hydrogen during discharge. Such a hydrogen storage alloy may have a structure represented as ABx class where A is a hydride-forming element, B is a non-hydride-forming element, and x is a real number of 1-5. The hydride-forming element (A) may optionally be but is not limited to lanthanum, cerium, praseodymium, neodymium, promethium, samarium, yttrium, titanium, zirconium, or combinations thereof, or other metal(s) such as a mischmetal. The non-hydride-forming element may optionally be but is not limited to a metal such as aluminum, nickel, cobalt, copper, and manganese, or combinations thereof. Illustrative specific examples of a hydrogen-storage alloy include: an AB₅ type alloy such as LaNi₅ or MmNi₅ (Mm is a mischmetal); an AB₃ type alloy such as a rare earth-magnesium-nickel based alloy; an A₂B₇ type alloy such as a rare earth-magnesium-nickel based alloy forming a superlattice structure; and AB₂ type alloy such as (Zr,Ti) Ni₂, but are not limited thereto. Other examples of an anode-active material may include group 14 elements, or a compound or an alloy containing a plurality of group 14 elements, and may specifically be, carbon, silicon, silicon carbide (CₓSi₁₋ₓ), and a silicon germanium alloy (SiₓGe₁₋ₓ).

An anode-active material, a cathode-active material, or both may optionally be in a powder or particulate form. The particles may be held together by binders to form a layer on a current collector while the anode or cathode is formulated. Binders suitable for use in forming an anode, a cathode, or both may optionally be any binder known in the art suitable for such purposes and for the conduction of a proton.

Illustratively, binders for use in the formation of an anode may include but is not limited to polymer-type binder materials. Binder material may optionally be an elastomeric material, and illustrative specific examples in such cases include styrene-butadiene (SB), styrene-butadiene-styrene block copolymer (SBS), styrene-isoprene-styrene block copolymer (SIS), and styrene-ethylene-butadiene-styrene block copolymer (SEBS). Illustrative specific examples of binders include, but are not limited to, polytetrafluoroethylene (PTFE), polyvinyl alcohol (PVA), teflonized (“Teflon” is a registered trademark) acetylene black (TAB-2), styrene-butadiene binder materials, or carboxymethyl cellulose (CMC).

A cathode, an anode, or both may further include one or more type(s) of additives contained in the active materials. An example of an additive is a conductive material. A preferable conductive material may be a conductive carbon. Illustrative examples of a conductive carbon may include graphite, and other examples may include materials that contain graphitic carbons, such as graphitized cokes. Still other examples of possible conductive carbons may include non-graphitic carbons that may be amorphous or non-crystalline, such as petroleum cokes and carbon black. The ratio of conductive materials contained in an anode or a cathode is within a range of 0.1 wt % to 20 wt %.

An anode and a cathode may optionally be formed by any method known in the art. For example, an anode-active material or a cathode-active material may be mixed with binders, optionally in the presence of conductive materials, together with an appropriate solvent, resulting in a formation of a slurry. Such a slurry may be coated onto a current collector and this coating is dried so as to evaporate some or all of the solvent contained in the slurry, thereby an active material layer can be formed on the surface of the current collector.

A current collector may be formed in an aspect of mesh, foil, or other suitable aspects. For example, a current collector may be formed of an aluminum-based metal such as an aluminum alloy, nickel or nickel alloy, steel such as stainless steel, copper or copper alloys, or other kind of such materials. A current collector may be formed in an aspect of sheet, and further in an aspect of foil, solid substrate, porous substrate, grid, foam, or other aspects known in the art. A current collector may optionally be formed of any suitable electronically conductive and optionally impermeable or substantially impermeable material, including, but not limited to, copper, stainless steel, titanium, or carbon papers/films, a non-perforated metal foil, an aluminum foil, a cladding material including nickel and aluminum, a cladding material including copper and aluminum, nickel plated steel, nickel plated copper, nickel plated aluminum, gold, silver, and any suitable combination thereof.

The electrolyte used in the proton-conducting secondary battery according to the present embodiment is a non-aqueous electrolyte and may preferably contains an ion liquid.

The ion liquid in the electrolyte may contain an aprotic liquid, and one or more acids added to the aprotic liquid as a proton source. The aprotic liquid may be any compound that is suitable for use in an electrolyte except for the compounds which may react detrimentally with other compounds within the battery. An exemplary compound constituting the aprotic liquid may contain ammonium or phosphonium compounds, where the ammonium or phosphonium optionally includes one or more linear, branched or cyclic substituted, or non-substituted alkyl groups connected to nitrogen or phosphorus.

An aprotic compound may be an ammonium or phosphonium compound with 1, 2, or more linear, branched or cyclic substituted, or non-substituted alkyls bound to a positively charged nitrogen or phosphorus atom. The nitrogen or phosphorus is a constituent element of a 5 or 6 membered ring structure that may have one or more pendant groups extending from the central ring. For example, an ammonium ion may be an imidazolium ion, and a phosphonium ion may be a pyrrolidinium ion.

Ammonium or phosphonium includes 1 or 2 linear or cyclic, substituted or non-substituted alkyls of 1-6 carbon atoms. Optionally, the alkyl includes 2, 3, 4, 5, or 6 carbons. A substitution in such an alkyl may be a nitrogen, oxygen, sulfur, or other such element.

Illustrative examples of an aprotic compound for use as an electrolyte include, but are not limited to 1-butyl-3-methylimidazolium (BMIM), 1-ethyl-3-methylimidazolium (EMIM), 1,3-dimethylimidazolium, 1,2,3-trimethylimidazolium, tris-(hydroxyethyl)methylammonium, 1,2,4-trimethylpyrazolium, or combinations thereof.

The aprotic compound optionally includes one or more anions in conjunction with the aprotic compound as necessary. Illustrative examples of such an anion include but are not limited to methides, nitrates, carboxylates, imides, halides, borates, phosphates, phosphinates, phosphonates, sulfonates, sulfates, carbonates, and aluminates. Further illustrative examples of such an anion include carboxylates such as an acetate, phosphates such as hydrogen, alkyl, or fluorophosphate, and phosphinates such as alkyl phosphinates, among. Illustrative examples of such aprotic compounds include but are not limited to acetates, sulfonates, or borates of 1-butyl-3-methylimidazolium (BMIM), 1-ethyl-3-methylimidazolium (EMIM), 1,3-dimethylimidazolium, 1,2,3-trimethylimidazolium, tris-(hydroxyethyl)methylammonium, 1,2,4-trimethylpyrazolium, or combinations thereof. Specific examples of such a compound include diethylmethylammonium trifluoromethanesulfonate (DEMA/TfO), 1-ethyl-3-methylimidazolium acetate (EMIM/AC), and 1-butyl-3-methylimidazolium bis(trifluoromethylsulfonyl)imide (BMIM/TFSI).

A salt may be added to the ion liquid of the electrolyte as a pH buffer, as necessary. The salt to be added may be an organic salt or an inorganic salt. Illustrative examples of an organic salt include, but are not limited to, potassium or sodium citrate, and potassium or sodium oxalate. Illustrative examples of an inorganic salt include, but are not limited to, potassium or sodium phosphate, carbonate, and hydrosulfate. The acid dissociation constant (pKa) of the salt additives in an aqueous solution may be within a range of 1-14. The pKa of the salt may be lower than 7, further lower than 3, and still further lower than 1.5.

The proton conducting secondary battery may include a separator interposed between the anode and the cathode. The separator may be permeable to a hydrogen ion so as not to appreciably or unacceptably restrict movement of ions between the anode and the cathode. Illustrative examples of a separator include, but are not limited to, materials such as nylons, polyesters, polyvinyl chloride, glass fibers, and cotton. Illustratively, a separator may be polyethylene or polypropylene.

The anode, the cathode, the separator, and the ionic liquid for use as an electrolyte are enclosed in a housing. The housing may be in formed into an aspect of a metal or polymer can, or may be formed into a laminate film, such as a heat-sealable aluminum foil, an example of which may be an aluminum coated polypropylene film. As such, an electrochemical cell as provided herein may be formed into any known configuration, and may be, illustratively, a button cell, a pouch cell, a cylindrical cell, a square cell, or other suitable types of cells.

The current collector and/or substrates may include one or more tabs to allow the movement of electrons from the current collector to a region exterior of the cell and to connect the current collector(s) to a device such as a circuit. A tab may be formed of any suitable conductive material (e.g., nickel, aluminum, or other metal) and is connected to the current collector by means such as welding.

In the following, the present invention will be described specifically by referring to examples, but is not limited thereto.

### EXAMPLES

### Production of Test Cells

A cathode active material according to Example 1-1 was produced by the following procedures (1) to (6) (hereinafter, referred to as “procedure (1-1)”).
(1) Each of 10 g of NiSO₄·6H₂O, 10.7 g of CoSO₄·7H₂O, and 6.4 g of MnSO₄·H₂O was individually dissolved in 100 ml of distilled water. Then, the aqueous solutions as prepared above were mixed, and water was further added thereto until the total volume became 500 ml.
(2) 60 g of NaOH and 15.6 g of Na₂CO₃ were dissolved in 500 ml of distilled water.
(3) 6.4 g of NH₄Cl was dissolved in 100 ml of distilled water, and then NH₃·H₂O was added to the distilled water until the pH became 10.
(4) The aqueous solution of (1) and the aqueous solution of (2) were put into the aqueous solution of (3), while the pH was adjusted so as to be maintained within a range of 10-10.2. The total amount of the aqueous solution of (1) was put into the solution of (3), and then the aqueous solution of (2) was further put into the solution of (3) so as to increase the value of pH to 11.0-11.2.
(5) The aqueous solution of (4) was continuously stirred at room temperature for 5 hours, and then was allowed to stand at 60° C. for 8 hours. The final value of pH was 11.0-11.4.
(6) The aqueous solution of (5) was filtered, then washed with distilled water, and further dried at 60° C. for 5 hours.

A cathode active material according to Example 1-2 was produced by the following procedures (1) to (3) (hereinafter, referred to as “procedure (1-2)”).
(1) 3 g of the material obtained from the procedure (1-1) was heated with an air furnace at 120° C. for 3 hours.
(2) The temperature of the air furnace was increased from 120° C. to 550° C. at a rate of 10° C./min., and then the material was heated at 550° C. for 8 hours.
(3) The heating with the air furnace was stopped, and the material was allowed to cool to room temperature.

A cathode active material according to Example 1-3 was produced by the following procedures of (1) to (3) (hereinafter, referred to as “procedure (1-3)”).
(1) 5 g of the material obtained through procedure (1-1) was mixed with 2 g of LiOH·H₂O.
(2) 9 g of KOH was dissolved in 21 g of distilled water.
(3) A solution was prepared by putting the powder of (1) into the aqueous solution of (2) and then heated in a solution tank at 70° C. for 8 hours.
(4) The solution of (3) was heated with an air furnace at 120° C. for 3 hours.
(5) The temperature of the air furnace was increased from 120° C. to 800° C. at a rate of 10° C./min., and then the solution was heated at 800° C. for 8 hours.
(6) The heating with the air furnace was stopped, and the solution was allowed to cool to room temperature.

A cathode-active material according to Example 2-1 was produced by a procedure the same as procedure (1-1), except that 10 g of NiSO₄·6H₂O, 10.7 g of CoSO₄·7H₂O, 16.0 g of MnSO₄H₂O, and 8.6 g of LiOH·H₂O were used as raw materials. In addition, a cathode active material according to Example 2-2 was produced by a procedure the same as procedure (1-2) except that the above materials were used as raw materials instead. Furthermore, a cathode-active material according to Example 2-3 was produced by a procedure the same as procedure (1-3) except that the above materials were used as raw materials instead.

A cathode active material according to Example 3-1 was produced by a procedure the same as procedure (1-1) except that 2 g of MnO₂ was further added to the aqueous solution of (1) in procedure (1-1). In addition, a cathode active material according to Example 3-2 was produced by a procedure the same as procedure (1-2) except for the above. Furthermore, a cathode active material according to Example 3-3 was produced by a procedure the same as procedure (1-3) except for the above.

A cathode-active material according to Example 4 was produced by the following procedures (1) to (4) (hereinafter, referred to as “procedure (4)”).
(1) 50 g of Mn (NO₃)₂·4H₂O was dissolved in 80 ml of distilled water, and then mixed with 6.4 ml of an HNO₃ solution.
(2) While the aqueous solution of (1) was being stirred, the temperature thereof was increased to 125° C. at a heating rate of 5° C./min., and then the aqueous solution of (1) was allowed to stand at 125° C. for 12 hours in a vacuum condition.
(3) The aqueous solution of (2) was further heated at 325° C. for 5 hours with an air furnace.
(4) Then, the resulting material was broken up with a pestle and a mortar.

A cathode-active material according to Example 5 was produced by a procedure the same as procedure (4) except that, instead of 6.4 ml of the HNO₃ solution in procedure (4), a solution obtained by dissolving 4.27 g of Bi(NO₃)₃·5H₂O in a mixed liquid constituted from 18.6 ml of distilled water and 6.4 ml of an HNO₃ solution was used.

As a comparative example featured by a cathode-active material having a composition without Mn, Ni_{0.87}Co_{0.08}Zn_{0.05}(OH)₂ was produced by a coprecipitation method, and the obtained powder was coated with 2 wt % of cobalt oxyhydroxide (CoOOH) to obtain the resultant particles, and powder of the resultant particles was used for the example.

The composition of each cathode active material produced thus is illustrated in Table 1.

TABLE 1

| | Composition element | | | | | | | |
|---|---|---|---|---|---|---|---|---|
| | Mn | Co | Ni | Zn | Li | Bi | O | H |
| Example 1-1 | 0.33 | 0.33 | 0.33 | | | | 2 | 2 |
| Example 1-2 | 0.33 | 0.33 | 0.33 | | | | 2 | |
| Example 1-3 | | | | | | | | |
| Example 2-1 | 0.25 | 0.10 | 0.10 | | 0.55 | | | |
| Example 2-2 | 0.25 | 0.10 | 0.10 | | 0.55 | | | |
| Example 2-3 | | | | | | | | |
| Example 3-1 | 0.44 | 0.28 | 0.28 | | | | 2 | 2 |
| Example 3-2 | 0.44 | 0.28 | 0.28 | | | | 2 | |
| Example 3-3 | | | | | | | | |
| Example 4 | 1 | | | | | | 2 | |
| Example 5 | 0.95 | | | | | 0.05 | 2 | |
| Comparative | | 0.08 | 0.87 | 0.05 | | | 2 | 2 |
| Example | | | | | | | | |

Powder of each cathode-active material described above was mixed with a TAB-2 binder in a dried state at a weight ratio of 1:3, and the mixture was pressed onto a nickel mesh substrate as a current collector, to produce a cathode.

As an anode-active material, a superlattice-hydrogen storage alloy (A₂B₇ type) produced by a standard method, which is commercially available, was used.

As an electrolyte, EMIM/AC (purity>95%) containing 3.33 m of acetic acid was used.

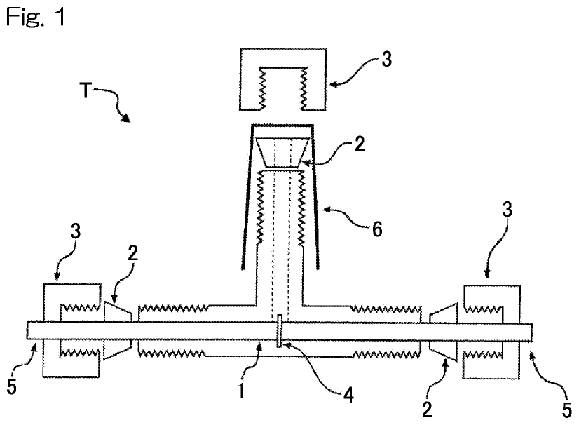

To perform a comparison test of electrochemical characteristics with respect to a cathode active material according to each of the examples and comparative example described above, an electrochemical cell for the test was produced inside an all-teflon Swagelok tee. The structure of the test cell T used in the charging/discharging test is illustrated in FIG. 1. The test cell T includes a center ground 1, and the center ground 1 is capped with ferrules 2 at both ends, the both ends secured by collars 3. A sample 4 is sandwiched between two current-collector rods 5 made from Ni-plated steel (NS), the sample 4 inserted in the center ground 1. The top channel of the test cell T is covered with a parafilm 6 as a pressure-vent device. The sample 4 was formed as a sandwich of the anode and the cathode separated by a standard-type separator. The test cell T was flooded with the above-described electrolyte.

### Test Results

Charge/discharge-cycle tests of the test cell produced thus were performed under the following charge/discharge conditions:
as to the charge condition, a charge rate was 500 mA/g, an end-of-charge voltage was 3 V, and a charging time was 3 hours (2 hours for the 11th-cycle); and
as to the discharge condition, a discharge rate was changed in the order of 50 mA/g, 10 mA/g, and 2 mA/g, and each end-of-charge voltage was 0 V.

The above charge rate and discharge rate was a value per weight (g) of the cathode active material respectively. Results are illustrated in Table 2.

TABLE 2

| Discharge Rate | 50 mA/g | 10 mA/g | 2 mA/g | Total |
|---|---|---|---|---|
| Example 1-1 | 56 | 140 | 237 | 433 |
| Example 1-2 | 88 | 267 | 488 | 843 |
| Example 1-3 | 54 | 140 | 591 | 746 |
| Example 2-1 | 64 | 267 | 396 | 551 |
| Example 2-2 | 74 | 101 | 473 | 688 |
| Example 2-3 | 58 | 91 | 457 | 568 |
| Example 3-1 | 52 | 141 | 341 | 543 |
| Example 3-2 | 61 | 53 | 283 | 535 |
| Example 3-3 | 57 | 150 | 478 | 619 |
| Example 4 | 120 | 191 | 939 | 1330 |
| Example 5 | 120 | 84 | 219 | 500 |
| Comparative Example | 17 | 98 | 219 | 354 |

As is obvious from Table 2, each example cell in which a material having a composition containing manganese was used as the cathode-active material all showed a more excellent-discharge capacity than the comparative-example cell which is a cathode-active material of a conventional-type not containing manganese. More specifically, each example cell showed a more excellent discharge capacity, with respect to any of the total-discharge-capacity of discharges of the three discharge rates and the discharge capacity at the first stage (50 mA/g) of the largest discharge rate, than the comparative example cell.

In particular, Example 4 in which 100% of the metal element was occupied by manganese showed the most excellent discharge characteristics among the examples, and showed the total discharge capacity of 3.8 times as much as that of the comparative example cell, indicating that said capacity has been greatly improved.

In addition, Example 5, in which 95% of the metal element was occupied by manganese, showed an excellent discharge capacity equal to that of Example 4 at the first stage of the high-rate discharge.

As a result, a material containing manganese can be used as a cathode active material for a proton conducting secondary battery, whereby the discharge capacity and the charge/discharge cycle characteristics of the proton conducting secondary battery can be remarkably improved.

Although the present invention has been described above in connection with the preferred embodiment thereof with reference to the accompanying drawing, numerous additions, changes, or deletions can be made without departing from the gist of the present invention. Accordingly, such additions, changes, or deletions are to be construed as included in the scope of the present invention.

What is claimed is:

1. A cathode-active material for a proton-conducting secondary battery, the cathode-active material being for use in a proton-conducting secondary battery, the cathode-active material comprising a compound that is a solid solution that has a composition containing Mn.

2. The cathode-active material for a proton-conducting secondary battery as claimed in claim 1, wherein the cathode-active material is a compound having a composition represented by the following formula (1):
MnₐM₁₋ₐOₓH_{y} (1)
(wherein M represents a metal element other than Mn or a combination of metal elements; 0<a≤1; 1≤x≤4; and 0≤y≤7).

3. The cathode-active material for a proton-conducting secondary battery as claimed in claim 2, wherein M in the formula (1) is one element selected from a group consisting of Co, Ni, Li, and Bi, or a combination thereof.

4. The cathode-active material for a proton-conducting secondary battery as claimed in claim 2, wherein a>0.5 in the formula (1).

5. The cathode-active material for a proton-conducting secondary battery as claimed in claim 2, wherein a>0.8 in the formula (1).

6. The cathode-active material for use in a proton-conducting secondary battery as claimed in claim 2, wherein a>0.9 in the formula (1).

7. The cathode-active material for use in a proton-conducting secondary battery as claimed in claim 2, wherein a>0.95 in the formula (1).

8. A proton-conducting secondary battery comprising:
a cathode with a cathode-active material as claimed in claim 1;
an anode with an anode active material capable of storing and releasing hydrogen; and
a non-aqueous electrolyte interposing between the cathode and the anode.
